(19) United States
(12) Patent Application Publication
(10) Pub. No.: US 2005/0162517 A1
(43) Pub. Date: Jul. 28, 2005

(54) Method and apparatus for testing image pickup device

(75) Inventors: Katsumi Fujihara, Kawasaki (JP); Susumu Haga, Kawasaki (JP); Takeo Shigihara, Kawasaki (JP); Yuji Akasaki, Aizuwakamatsu (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/019,117

(22) Filed: Dec. 22, 2004

(30) Foreign Application Priority Data
Dec. 26, 2003 (JP) 2003-432881

(51) Int. Cl. H04N 17/00

(52) U.S. Cl. 348/187; 348/92

(57) ABSTRACT

An image-pickup-device testing method according to an aspect of the present invention, wherein processes are performed at one stage, the processes includes mounting a image pickup device under test on a test desk, performing an electrical test on the mounted image pickup device, then performing automatic focus adjustment, then performing an image test; then performing a flicker test; then fixing a lens, and then measuring assembly dimensions of the image pickup device under test.

### BACKGROUND OF THE INVENTION

1) Field of the Invention

The present invention relates to a method and apparatus for testing an image pickup device, such as a charge-coupled device (CCD) or a complementary metal oxide semiconductor (CMOS). In recent years, with the advance of semiconductor technology, dramatic improvement has been achieved in definition of image pickup devices, such as CCDs and CMOSes. Digital cameras with as much as over three million pixels have been commercially available recently. Accordingly, how to test such an image pickup device efficiently has been a problem.

2) Description of the Related Art

In an exemplary known system for testing a CCD (for example, refer to Japanese Patent Laid-Open Publication No. 2000-243803, pp. 3-4, FIG. 1), an output analog signal from a device under test (DUT) mounted on a test head is transmitted with low noise to a sample and hold circuit of a CCD testing apparatus body. Here, the output signal from the DUT may be digital.

FIG. 15 is an illustrative drawing of a conventional testing method. Upon start of testing and adjusting a device under test mounted on a test desk (test jig), (a) an electrical test is first performed, (b) focus adjustment is then performed, and next (c) an image test is performed. Since the image test may be performed with different lightings and initial conditions, a separate image testing apparatus may be used for image testing (d). Next, (e) a filcker test is performed, and then (f) a lens is bonded (fixed). Finally, (g) an assembly dimension of the device under test is checked.

In these processes, upon completion of one test of the device under test, an operator performs a procedure of carrying the device under test to the next test apparatus for each test desk. As shown in the drawing, these tests are performed in the order of (a)→(b)→(c)→(d)→(e)→(f)→(g). Here, each test is described in detail.

(a) Electrical Test

The electrical test is to determine the characteristic of the image pickup device (for example, whether a signal of one channel has been leaked to another channel). As an electrical test apparatus 3, an LSI tester as shown in the drawing is used. 4 is a pass/fail decision displaying unit for displaying a pass/fail decision. 2 is a device under test, and a CCD or CMOS is used, for example. This device under test 2 is not a device with a single pixel, but is an array of 200×300 devices, for example. 1 is a test jig (test desk) on which the device under test 2 is mounted. As such, the device under test 2 mounted on the test desk 1 is moved for each process. The results of the electrical test are displayed on the pass/fail decision displaying unit 4 of an LSI tester. For example, a green light comes on when the operation is OK, and a red light comes one when the operation is NG.

(b) Focus adjustment

A pattern (chart) 9 for focus adjustment is disposed 60 centimeters away from the device under test, for example, and is illuminated by a pattern illuminating unit 8. In this state, the pattern for focus adjustment is read by the device under test 2. Next, a connection-confirming and image-testing unit 7 performs signal processing, and then a read image pattern is displayed on a focus adjustment monitor 10. While viewing the pickup image displayed on the focus adjustment monitor 10, the operator operates a focus adjustment jig 6 to adjust the position of a lens in the devise under test so that the image displayed on the focus adjustment monitor 10 comes into focus.

(c) First Image Test

With the use of the device under test 2 after focus adjustment, an image test pattern 11 is read. Examples of the image test pattern include a white chart, black chart, and a pattern chart. The read image is tested to see whether, for example, a full white image is displayed on a monitor (not shown) in the case of reading a white chart, a full black image is displayed thereon in the case of reading a black chart, or a predetermined pattern is displayed thereon.

(d) Second Image Test

A second image test may be performed if an image test is required with various illuminations and initial conditions.

(e) Flicker Test

When an image is shot under a fluorescent lamp, flicker of the fluorescent lamp may influence the image. To get around this problem, measures have been taken to prevent the image pickup device from suffering the flicker influence. In a flicker test, it is checked whether this measures have been fully taken. Specifically, light is emitted from a flicker test light source 13 for a flicker test on the device under test 2. An image optically-received by the device under test 2 is input to the connection-confirming and image testing unit 7 for determining the flicker influence.

(f) Lens Bonding

The position of the lens (image pickup lens) is kept in focus adjustment described above. To fix the position of the lens, the lens is bonded to the device under test 2. For bonding, an adhesive is used. The adhesive is applied to the perimeter of the lens for bonding to the device under test 2.

(g) Assembled Dimension Check

It is tested whether outer dimensions of the device under test subjected to the processes (a) to (f) are within predetermined reference values. Since the device under test is to fit in a small digital camera or cellular phone, the device under test cannot be used unless it has accurate dimensions. Therefore, the device under test is measured by a dimension measuring machine 15 to determine whether the outer dimensions of the device under test are within the predetermined reference values.

In practice, the tests are performed with a plurality of devices under test passing through the processes shown in FIG. 15. Then, in the tests, devices with failed operations are discarded. Only the devices with normal operations are regarded as satisfactory products with adjustment completed for use.

However, there are problems in the conventional arts as follows.

1) In the image-pickup-devise testing, the electrical test is first performed, and then the image test is performed on a device under test whose results of the electrical test are normal. However, these tests cannot be performed at one place, and therefore the, device under test has to be subjected to electrical connection for each test for check. In this check, a simple electrical test is required for each testing stage ((a) to (g) in FIG. 15) to check the connection is perfect. Moreover, with a plurality of times of electrical connection, terminals (electrodes) wear out, thereby posing problems, such as erroneous decision on a good product due to contact failure and degradation in terminal portions of the device under test.

2) In the image test, when different patterns are used depending on the test details, a test-pattern-printed sheet has to be changed to another. This is inefficient in testing. To avoid this, if different patterns are separately provided, as mentioned in 1), whether connection is perfect has to be determined for each stage, thereby increasing cost and testing time.

3) In the conventional chart-paper scheme, it is difficult to uniformly illuminate the entire test pattern, and thus uneven illumination (uneven development) tends to occur.

4) As for the light source for testing, its light amount and chromaticity have to be calibrated on a regular basis. If a plurality of light sources is present, however, a calibrating operation is complex and takes a long time.

5) The life of the light source (particularly, fluorescent lump) for use in the image test is extremely decreased when it is repeatedly turned ON/OFF, and has a characteristic of low stability at the time of start-up, thereby making it impossible to efficiently perform the test (the low start-up characteristic increases the testing time). Therefore, a light source has to be provided for each test item. Moreover, with such a complex illumination system, each light shield may be incomplete to causing a light leak, thereby making it impossible to perform a correct test.

6) As for lens focusing, the focus state is determined by an operator through visual inspection. Therefore, the determination values may vary depending on individual difference and operation elapsed time.

7) Moreover, at the time of focusing, it is not known which side the initial lens position is located with respect to the focus position. Therefore, the focus position has to be checked by assuming the focus position at both sides. This increases a focusing time.

8) After focusing, the lens is bonded with an adhesive and is dried. However, with exacting specifications being applied to the amount of the adhesive and bonding parts, the operation is difficult. This difficulty greatly increases the adhesive drying time after bonding, thereby hindering a reduction in manufacturing tact.

9) Various check points are required for the device under test. With many handling operations by operators and apparatuses, there is a high probability that the device under test will be broken during the testing.

### SUMMARY OF THE INVENTION

It is an object of the present invention to solve at least the problems in the conventional technology.

An image-pickup-device testing method according to an aspect of the present invention, wherein processes are performed at one-stage, the processes includes mounting a image pickup device under test on a test desk, performing an electrical test on the mounted image pickup device, then performing automatic focus adjustment, then performing an image test; then performing a flicker test; then fixing a lens, and then measuring assembly dimensions of the image pickup device under test.

An image-pickup-device testing apparatus according to another aspect of the present invention for performing an electrical test, an image test, and focusing and fixing of a lens of an image pickup device, the apparatus comprises, an automatic focus adjusting mechanism that automatically perform focus adjustment of a device under test, an image test display unit that displays a pattern for testing an image reading function of the device under test, an electrical testing and image testing unit that performs the electrical test and the image test on the device under test, a flicker testing unit that performs a flicker test, a moving unit that moves various components as required, and a system controlling unit that controls an entire operation.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a drawing of the configuration of one embodiment according to the present invention;

FIG. 2 is an exemplary section view of a device under test;

FIG. 3 is an illustrative drawing of an electrical test and an image test;

FIG. 4 is an illustrative drawing of lens fixing and measurement;

FIG. 5 is drawing of switching among a display unit for image test, a flicker test light source, and a focus adjustment chart;

FIGS. 6A and 6B are illustrative drawings of a testing method with luminescent spots and defects of the display unit being eliminated;

FIG. 7 is an illustrative drawing of focus adjustment;

FIG. 8 is an illustrative drawing when focus adjustment is performed with long focus;

FIG. 9 is a drawing of exemplary arrangement of display units;

FIG. 10 is an illustrative drawing of arrangement of a display unit;

FIG. 11 is a drawing of the structure of an automatic focusing mechanism;

FIG. 12 is a drawing of an exemplary definition characteristic at the time of automatic focusing;

FIG. 13 is an illustrative drawing of lens position correction;

FIG. 14 is a drawing of an exemplary structure of a system controlling unit; and

FIG. 15 is an illustrative drawing of a conventional testing method.

### DETAILED DESCRIPTION

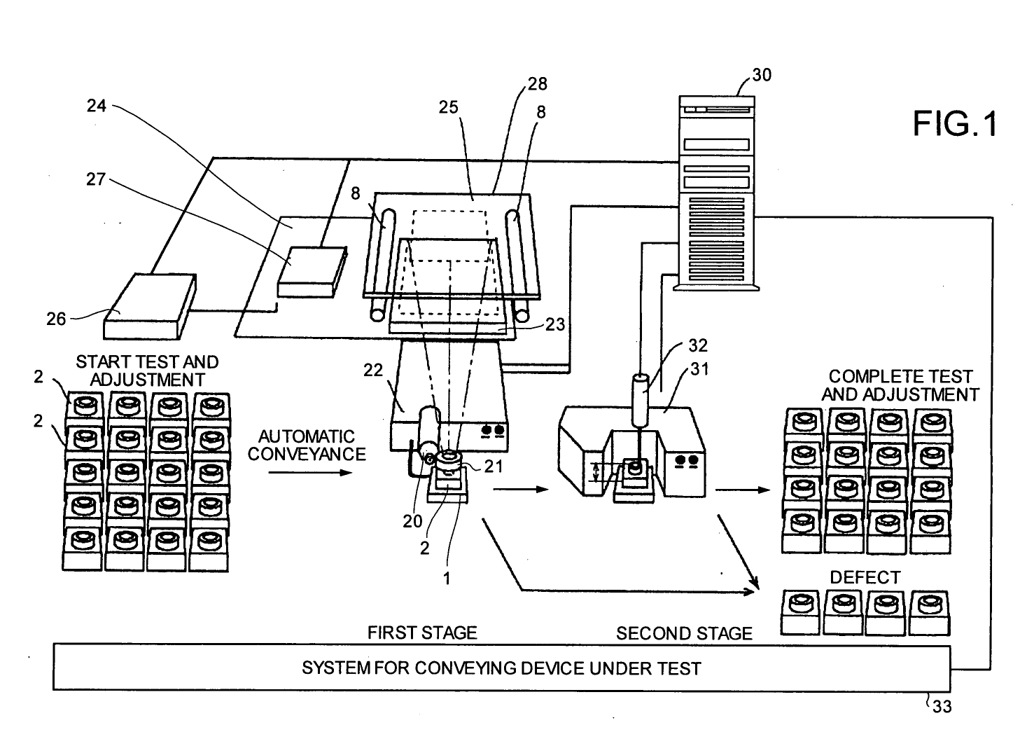

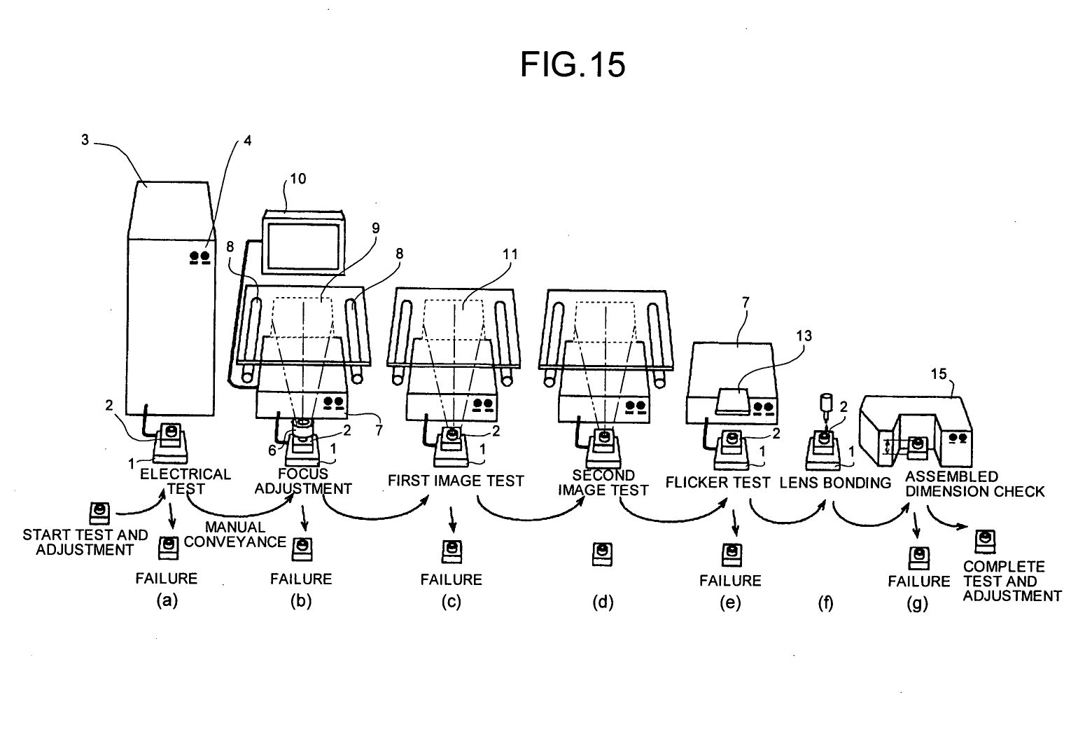

FIG. 1 is a drawing of the configuration of one embodiment according to the present invention. Components identical to those in FIG. 15 are provided with the same reference numerals. In the drawing, 1 is the test desk (test jig) on which the device under test 2 is mounted, 21 is a knob for adjusting the lens position of the devices under test 2, and 20 is an automatic focus adjusting mechanism that automatically rotates the knob 21. As shown in the drawing, a plurality of devices under test 2 is disposed.

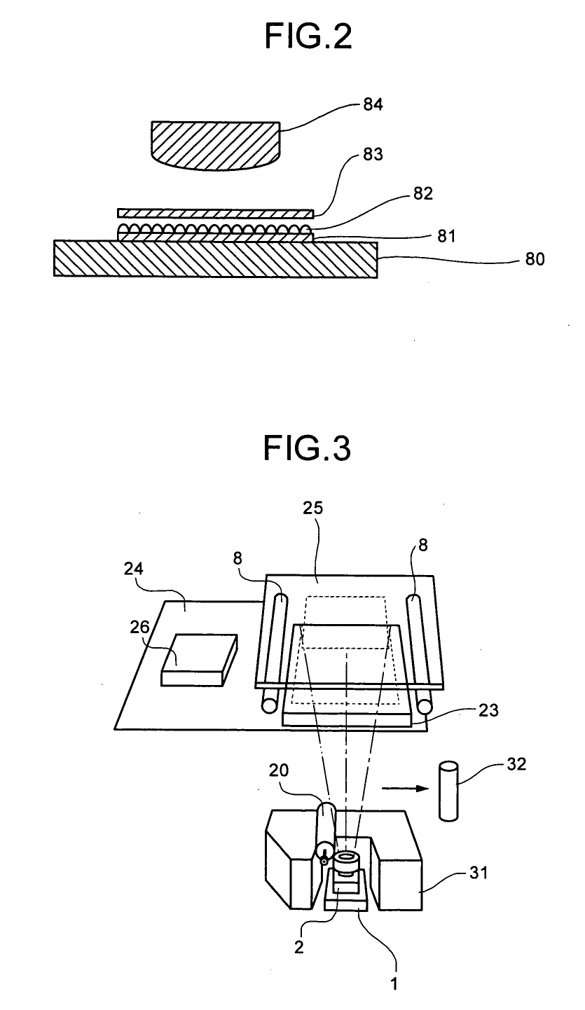

FIG. 2 is an exemplary section view of the device under test. In the drawing, 80 is a substrate, 81 is a CCD device formed on the substrate 80, and 82 is a microlens formed on the CCD device 81. The microlens 82 is to bring light to the entire surface of the CCD device 81. 83 is an RGB filter disposed on the microlens 7.2. The RGB filter includes three types of filters letting only red (R), green (G), and blue (B), respectively, passing therethrough. 84 is an image pickup lens disposed on the RGB filter 83. These components are externally surrounded by a hood (not shown).

These devices under test 2 are mounted, one by one, on the test desk 1 for performing a series of tests. 22 is an electrical testing and image testing unit for performing an electrical test and an image test. To the electrical testing and image testing unit 22, an output from the device under test 2 is input.

28 is chart paper provided on the upper portion of the device under test 2. On the chart paper 28, a focus adjustment pattern 25 is formed. 8 is a pattern illuminating unit for pattern illumination. As the pattern illuminating unit 8, a fluorescent lamp is used, for example. 23 is a display unit for image test (hereinafter simply referred to as a display unit) provided on the low portion of the chart paper 28. As the display unit 23, a display unit having a flat display surface, such as a liquid crystal display (LCD) or a plasma display panel (PDP), is used, for example. 24 is a light-shield and pattern (light source) switching mechanism including a shielding film for shielding light from the chart paper 28, 26 is a light-shield and pattern (light source) switch driving system for driving the light-shield and pattern (light source) switching mechanism 24, and 27 is a flicker test light source.

30 is a system controlling unit that controls the operation of the entire apparatus, and is exemplarily implemented by a personal computer. The system controlling unit 30 is connected to the light-shield and pattern (light source) switch driving system 26, the flicker test light source 27, the electrical testing and image testing unit 22, and the automatic focus adjusting mechanism 20. 31 is a dimension measuring machine automatically moving the test desk 1 for dimension measurement. 32 is a lens welding laser for welding the lens onto the device under test 2. The lens welding laser 32 is also controlled by a signal from the system controlling unit 30. 33 is a system for conveying the device under test driven by the system controlling unit 30.

The drawing depicts the case where a first stage and a second stage are combined. However, the present invention is not meant to be restricted to this, but can be achieved by using only a single stage. In this case, in addition to the components described above, a lens welding laser and a dimension measuring function are required to be provided. The operation of the apparatus structured as mentioned above is described as follows.

Firstly, the device under test 2 is mounted on the test desk 1. Then, the device under test 2 mounted on the test desk 1 is subjected to the following tests. Firstly, the electrical testing and image testing unit 22 is used to perform an electrical test on the device under test 2. The electrical test is to test whether the device under test functions normally, such as to test continuity of each terminal and to check whether a leak or short to the adjacent terminal is present.

Next, the light-shield and pattern switch driving system 26 is used for focus adjustment with the display unit 23 being moved to an edge. Focus adjustment is performed by causing the device under test 2 to read the focus adjustment pattern 25. At this time, the automatic focus adjusting mechanism 20 is driven by the system controlling unit 30, thereby causing the knob 21 to be rotated (which will be described further below in detail).

Upon completion of focus adjustment, the entire surface of the chart paper 28 is covered with the shielding film of the light-shield and pattern (light source) switching mechanism 24. With this, the pattern illuminating unit 8 does not have to be turned OFF when the subsequent image test, thereby increasing the longevity of the pattern illuminating unit 8. Also, with no light leak, the image test can be accurately performed. In the image test, a predetermined pattern is caused to be displayed by the system controlling unit 30 on the display unit 23. The pattern is then read by the device under test 2, and is then input to the electrical testing and image testing unit.22. The electrical testing and image testing unit 22 performs a predetermined image process on the input image data for image test. The image test is to test whether the pickup device forming each device under test 2 has read the image of the display unit 23.

As such, according to the present invention, the image test on the device under test 2 can be automatically performed. Also, according to the present invention, the characteristic of the device under test can be automatically obtained with the test pattern being displayed on the display unit 23.

Furthermore, the image test is performed with the display unit 23 being disposed upstream from the focus point to throw the image out of focus. Therefore, a defective pixel in the display unit can be prevented from affecting the image test. Still further, the entire white image, for example, is read out of focus, thereby performing the image test of the device under test 2.

When the image test is completed, the flicker test light source 27 is illuminated by bringing the light-shield and pattern (light source) switch driving system 26 directly above the device under test 2 to cause the device under test 2 to read an image. Then, information indicating that no flicker occurs in the image is input to the electrical testing and image testing unit 22 for check.

When the flicker test is completed, then the test desk 1 is moved to the system 33 for conveying the device under test at the second stage. Next the system controlling unit 30 drives the lens welding laser 32 to weld and fix the lens onto the device under test 2. In conventional bonding with an adhesive, a long adhesion time is required, and therefore an operation has to be performed at another place. However, according to the present invention, by fixing the lens through laser, bonding at the same speed as that of any other test operation in the same apparatus can be achieved. Also, when bonding is performed at another place, the focus position set by the apparatus may possibly be displaced by vibration associated with moving. However, according to the present invention, the processes are performed in the same apparatus, thereby avoiding such an inconvenience.

As such, according to the present invention, a lens fixing unit (lens welding laser 32) is used to fix the lens in focus.

After fixing the lens by the lens welding laser 32 is completed, the dimension measuring machine 31 is used to measure dimensions of the device under test 2. The measured dimensional information is transmitted from the dimension measuring machine 31 to the system controlling unit 30. The system controlling unit 30 checks to see whether the measured dimensions of each parts of the device under test are within predetermined reference values or not. As such according the present invention, whether the dimensions of the device under test are within their tolerance range can be automatically determined.

Through a series of tests described above, a defective device under test 2 determined as NG is removed (discarded). As such, according to the present invention, whether the operation of the device under test 2 is normal can be automatically checked. Then a device under test 2 that have passed all the tests is put at a place where devices under test 2 with good quality should be laid.

In the foregoing, the operation of the present invention has been generally described. In this embodiment, the tests are performed at two stages, that is, the first stage and the second stage. Alternatively, as described above, all tests can be performed at only one stage.

As described above, according to the present invention, various tests can be performed at one stage, with the device under test being mounted on the test desk, thereby making it possible to test an image pickup device at low cost and with high production efficiency.

FIG. 3 is an illustrative drawing of the electrical test and the image test. Components identical to those in FIG. 1 are provided with the same reference numerals. In this embodiment, the test desk 1 fits in a concave portion of the dimension measuring machine 31. In this state, the lens welding laser 32 is moved to the edge. Then, with the lens welding laser 32 not obstructing anything, the electrical test and the image test are performed. Furthermore, with the light-shield and pattern (light source) switching mechanism 24 shielding the focus adjustment pattern 25 with the shielding film, the electrical test and the image test are performed. Then, while a predetermined pattern is being displayed on the display unit 23, the pattern is read by the device under test 2 for image test.

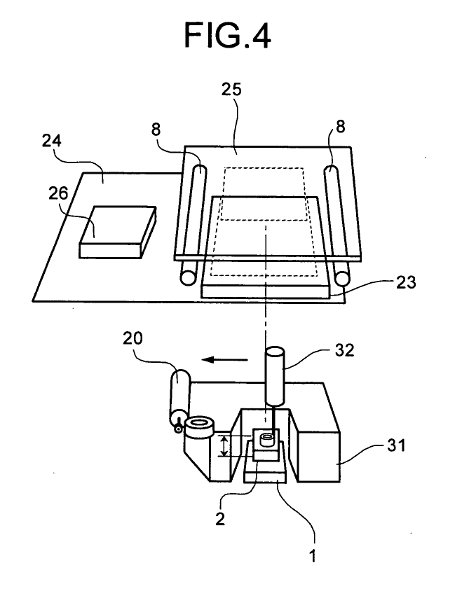

FIG. 4 is an illustrative drawing of lens fixing and measurement. Components identical to those in FIG. 1 are provided with the same reference numerals. In the state shown in FIG. 4, the lens welding laser 32 radiates laser light to weld the device under test 2 for fixing. After the lens is fixed, the dimensions of the device under test 2 are measured by the dimension measuring machine 31. As evident from the structures of FIGS. 3 and 4, the electrical test, the image test, and fixing the device under test 2 can be performed at the same stage.

According to the present invention, the electrical test, the image test, lens focusing, lens fixing, and lens dimension measurement are performed at the same place. Therefore, the connection between the device under test 2 and the testing system can be made at one time. Thus, breakage of the device under test 2 due to the handling operation by the operator and the apparatus and, particularly, degradation of an edge portion (electrode portion) of the device under test, can be prevented.

In the image test, which has conventionally been performed at a plurality of stages, for the occurrence of image pickup patterns of the image test, a flat display unit, such as a small LCD or PDP is combined with chart paper and an LED for flicker for arrangement. Depending on the test details, these components are switched as required for allowing the test to be performed at one stage. Also, when light sources (test patterns) are switched, ON/OFF of an unused light source is performed not through an electrical manner but through mechanical shielding, thereby stabilizing the light source and increasing the longevity of the light source. Also, according to the present invention, in association with the operation of switching among the display unit, the chart paper, and the flicker test light source, a dark screen test can be performed. With this, in association with the operation of switching among the display unit, the chart paper, and the flicker test light source, the dark screen test can be timely performed.

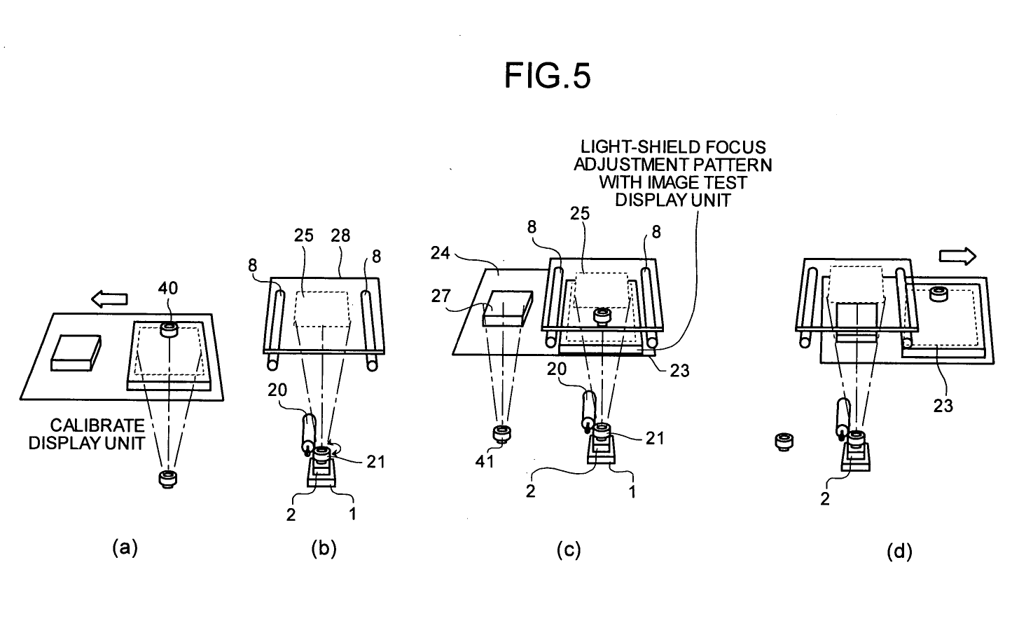

FIGS. 5A to 5D are drawing of switching among the display unit for image test, the flicker test light source, and a focus adjustment chart. FIG. 5(a) depicts calibration of the display unit 23. 40 is a light-amount and chromaticity-calibration sensor. The light-amount and chromaticity-calibration sensor 40 is used to calibrate the display unit 23. FIG. 5(b) depicts focus adjustment. In focus adjustment, the focus adjustment pattern 25 formed on the chart paper 28 is formed on the device under test 2. Then, the image pickup lens implemented on the device under test 2 is processed with the knob 21 being rotated by the automatic focus adjusting mechanism 20 in a predetermined direction. Specifically, a lattice pattern or the like is shot by the device under test 2, and then a position where the image becomes clearest is automatically found.

FIG. 5(c) depicts the image test. 41 is a light-amount and chromaticity-calibration sensor. The light-amount and chromaticity-calibration sensor 41 is used to calibrate the light amount and chromaticity. The image test is performed by using the display unit 23 with the focus adjustment pattern 25 being shielded by the light-shield and pattern switching mechanism 24. In the image test, a pattern displayed on the display unit 23 is shot by the device under test 2, and is then input to the electrical testing and image testing unit 22 (refer to FIG. 1) for the predetermined image test.

Next, flicker/light-shield test shown in FIG. 5(d) is described. In this example, the display unit 23 is moved to the edge by a moving mechanism (not shown) so that the flicker test light source 27 is placed directly above the device under test 2 for radiate light to the device under test 2, thereby performing a flicker test.

According to the present invention, focusing is first performed and, before lens bonding is performed, functions of the electrical test, the image test, and lens position measurement are provided. This can avoid an unnecessary bonding operation. With this, components can be reused, thereby decreasing cost. Also, the height of the lens and the focus position can be re-measured after bonding. Therefore, a final product test can be performed within the same apparatus.

Next, the image test is described in further detail.

1) By changing the pattern to be displayed on the display unit, for various tests, the number of test stages can be reduced to achieve efficient tests.

2) A flat display unit, such as an LCD or PDP, is used as the image pickup chart (pattern). In synchronization with an image pickup rate of the device under test, moving images are displayed on the display unit. With this, a dynamic test can be achieved.

3) Display units have a defective bit due to manufacturing reasons. Therefore, for the tests, a display unit with a definition such that the number of display pixels in both length and width is twice as many as the number of pixels of the device under test is used. With this, even if the display unit has defective bits to some extent due to defective manufacturing,.an adverse effect on the image test can be avoided.

4) Also, an image pickup device (or an illuminance and chromaticity measuring unit) whose image pickup sensitivity or the like is known in advance is provided for use in shooting the pattern on the display unit. To achieve predetermined values, brightness and chroma of each display pixel are adjusted. With this, a test pattern with arbitrary color and shape can be instantaneously displayed. Also, factors obstructing the test, such as uneven display, can be eliminated. Thus, the image test can be performed with extremely high uniformity.

5) To perform a test with further accuracy, a display unit having no (less) defective bits can be selectively used, but cost is extremely increased. To avoid this problem, a display unit that is somewhat large is selected in the structure of the following item 9), and then coordinates of a defective position on the display unit are checked before testing.

The test is performed such that, after an image is shot by the device under test, the display unit is slightly moved in parallel, an amount equivalent to the amount of movement is reflected on the pattern to be displayed on the displayed unit for display, and then an image is again shot. From the obtained two shot images, defective portions known in advance are eliminated, and then each image is tested or these images are combined as one image for testing. With this, defects of the display unit can be avoided.

6) In another scheme, a chart for focusing and a chart for another image test are separately provided. In the image test, the test chart (display unit) is brought out of focus, thereby preventing influences of a luminescent spot unique to the display unit and defective pixels. Furthermore, in the image test, the display unit is brought near the side of the device under test rather than the focus position, thereby reducing the size of the display unit.

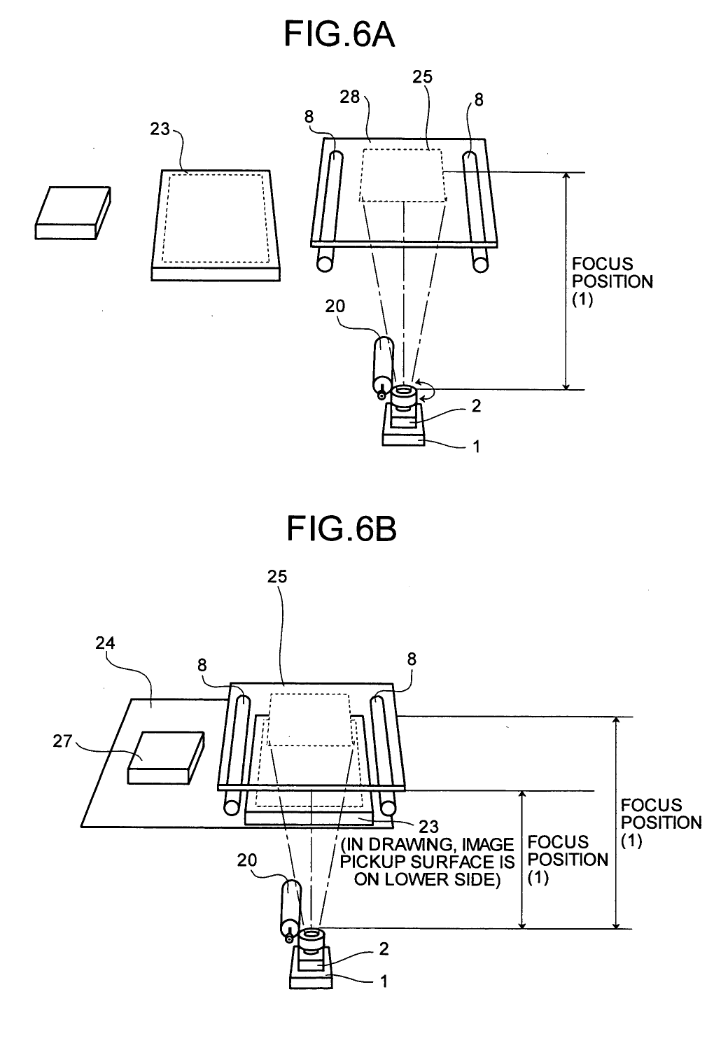

FIGS. 6A and 6B are illustrative drawings of a testing method with luminescent spots and defects of the display unit being eliminated. FIG. 6A depicts the state at the time of focus adjustment, and FIG. 6B depicts the state at the time of the image test. A the time of focus adjustment shown in FIG. 6A, the display unit 23 is banished to the edge, and the focus adjustment pattern 25 on the chart paper 28 is shot by the device under test 2. At this time, a focal length with the focus being adjusted is taken as a first focal length.

FIG. 6B depicts the state at the time of the image test. The focus adjustment pattern 25 is light-shielded by the light-shield and pattern switching mechanism 24. In such a light-shielded state, the pattern displayed on the display unit 23 is shot by the device under test 2. At this time, a distance from the display unit 23 to the device under test 2 is shorter than the first focal length. As a result, the image shot by the device under test 2 is blurred. With this, an influence of defective pixels on the display unit can be avoided.

7) As the display unit, a cathode-ray tube (CRT) display can be used. However, with such a display, it is difficult to accurately define the display pattern and size, and also it is slightly difficult to ensure the flatness of the display surface. Moreover, as is the case of the present invention, if the display unit is moved, the depth of the CRT display becomes an obstacle. Therefore, the CRT display is not suitable.

8) Also, for example, a projector can be used for radiating and forming a pattern from the back or slanting direction. However, there are problems similar to those of the CRT display. Therefore, application of the projector is difficult.

9) When the image test includes a test in a dark state, if a display unit, such as an LCD or PDP, is used, a display (light emission) be completely suppressed. Therefore, another measure is required for light shielding. Also, when a flicker operation test is performed, it is difficult to cause the display unit, such as an LCD or PDP, to blink at a required flicker frequency. Therefore, a light source for flicker is required to be disposed on the optical axis of the device under test.

Of these two requirements mentioned above, the former requirement is satisfied by providing a light-shielding shutter for light shielding at the time of the test. The latter requirement is satisfied by providing the shutter with a light source for flicker test (for example, LED light source), and the light source is illuminated for the test. With this, one mechanism can be shared. The flicker light source is turned OFF when the dark state is required (refer to FIG. 5). Also, when the focusing chart and the display unit for image test are switched as described in the item 6), the display unit is moved to still another position. Thus, illumination switching and light shielding are performed at three positions.

Next, lens focusing is described in detail.

1) In lens focusing, automatic adjustment is performed by, in place of visual inspection by the operator, driving with a motor a component for focus adjustment (knob) provided on the device under test. In focusing, attention normally focuses merely on a part, such as the center of the image pickup screen. Therefore, by reducing the size of the chart for use, downsizing of the apparatus is sought (as for focusing at a plurality of points, refer to the following item 4)).

2) Furthermore, the size of the chart is intentionally reduced to allow the surrounding image to be shot. From the obtained size of the surrounding image, it is determined whether the focus position is on the front or back of the present position, thereby increasing the speed of the focusing operation. The same effect can also be achieved when a pattern corresponding to the surroundings of the chart is used.

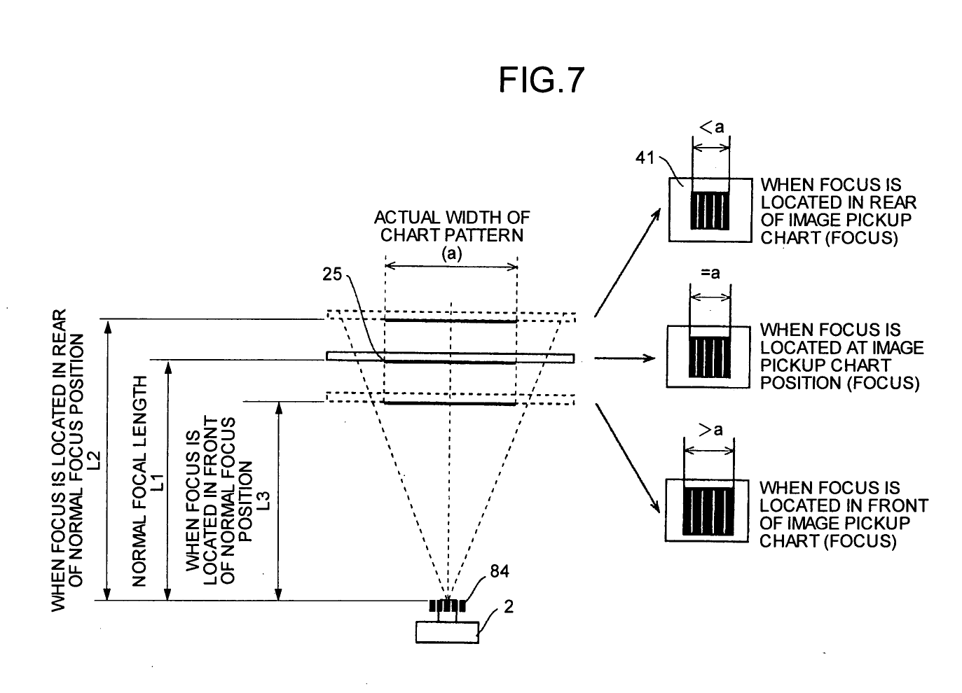

FIG. 7 is an illustrative drawing of focus adjustment. In the drawing, 25 is the focus adjustment chart pattern, and “a” is an actual width of the chart pattern. 84 is an image pickup lens, and 2 is the device under test on which an image of the chart pattern is formed. L1 is a normal focal length, L2 is a focal length when the focus is located in the rear of the normal focus position, and L3 is a focal length when the focus is located in front of the normal focus position. 41 is an image pickup screen on which the shot image is displayed. As shown in the drawing, on the shot image when the focus is located at the image pickup chart position, the chart is displayed with the length a. On the other hand, when the focus position is located in the rear of the chart, the width of the chart displayed on the display screen 41 is shorter than a. On the other hand, when the focus position is located in front of the chart, the width of the chart displayed on the display screen 41 is longer than a.

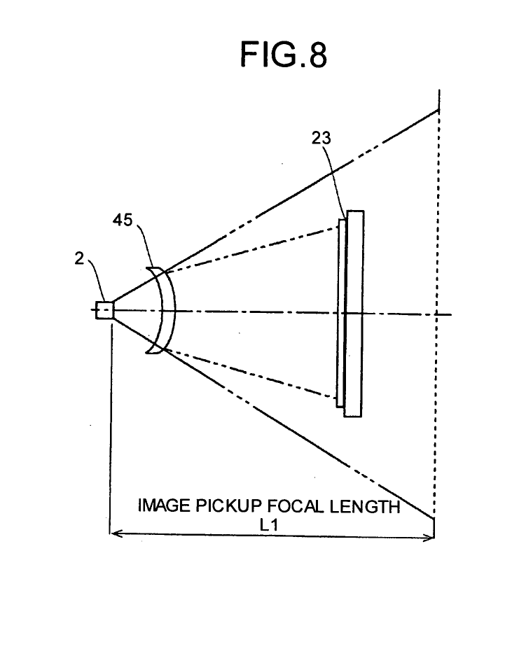

3) When focus adjustment is performed with long focus, a large-screen display unit is required, which is shown in FIG. 8. In the drawing, L1 is an image pickup focal length. Therefore, the display unit has to be placed the distance L1 away from the device under test 2, thereby requiring an extremely large display unit. To eliminate such an inconvenience, a meniscus lens 45 is disposed directly above the device under test 2. With this, a length equivalent to the focal length is shorter than L1, and therefore the required distance of the display unit 23 is significantly shorter than the distance L1. In this scheme, however, influences of the meniscus lens and shading have to be corrected.

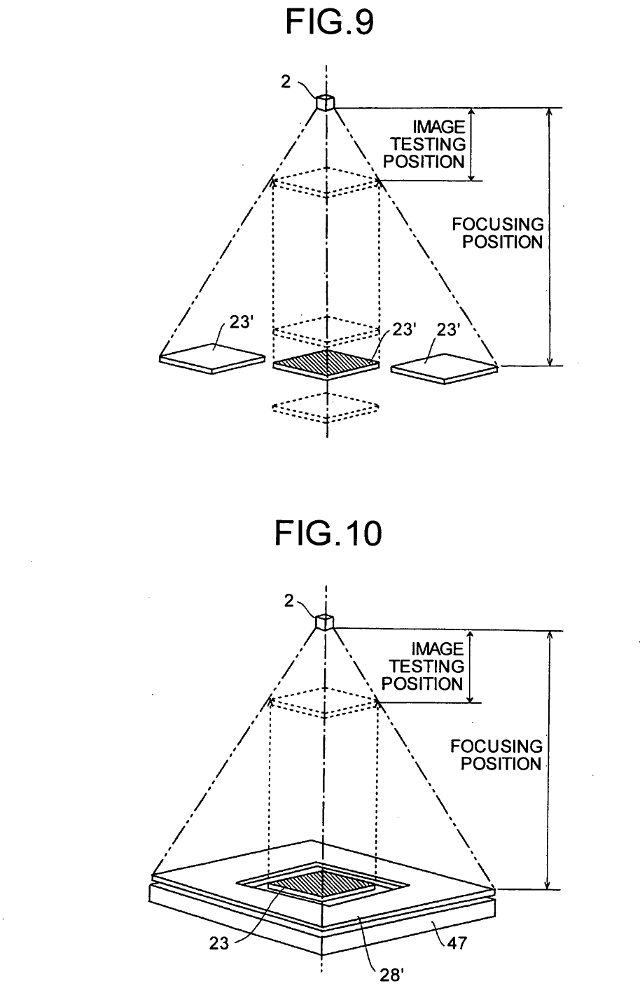

4) Another exemplary scheme of performing focus adjustment with long focus uses a plurality of small display units 23′ arranged as shown in FIG. 9. The number of units required is five at maximum, at two positions diagonally opposite to each other and three positions at the center. For focus adjustment, evaluations are made not necessarily on the entire area of the shot image but on a limited area including the center portion and four corners. Also, the display units 23′ may be spaced apart from one another. When an image quality test is performed with such a structure, the display unit 23′ at the center portion is brought near the device under test 2 for evaluation.

5) In the structure described in 4), if the display units disposed around the center portion are used only for focusing, the pattern is not required to be changed. Therefore, chart paper with a hollow at the center may be used. FIG. 10 is an illustrative drawing of arrangement of the display unit. In the drawing, 23 is the display unit, 28′ is chart paper with a hollow at the center, and 47 is transillumination for the chart. In this scheme, it is required to prevent illumination of the chart paper from leaking to the display unit 23 at the center. Therefore, illumination of the chart paper is desirably transillumination from the back.

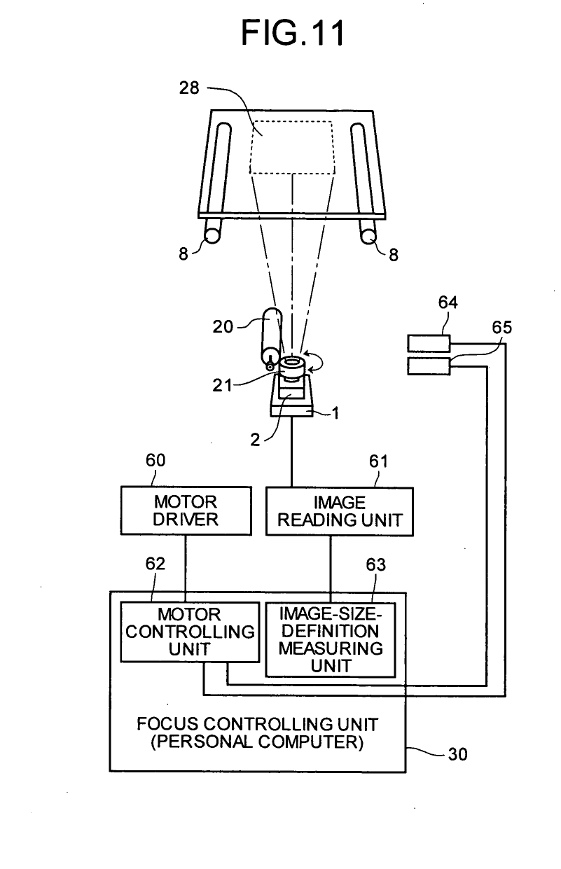

Next, automatic focusing is described in detail. FIG. 11 is a drawing of the structure of an automatic focusing mechanism. In the drawing, 28 is focusing chart, and 8 is a chart illumination for illuminating the focusing chart. 20 is a focus driving motor that serves as an automatic focus adjusting mechanism that rotates the focus adjusting cup (knob) 21 in a predetermined direction, 2 is the device under test, and 1 is the test desk. 64 is a tip limit sensor, and 65 is a depth limit sensor. These sensors 64 and 65 are to limit the rotation of the focus adjusting cup 21.

60 is a motor driver for driving the focus driving motor 20, 61 is an image capturing unit that captures an image signal of an image shot by the device under test 2. 30 is a focus controlling unit, which corresponds to the system controlling unit 30 shown in FIG. 1. In the focus controlling unit 30, 62 is a motor controlling unit that sends a control signal to the motor driver 60 to control the focus driving motor 20, and 63 is an image-size-definition measuring unit that inputs image data from the image capturing unit 61 to measure the definition of the image size. The operation of the mechanism having the structure as described above is described as follows.

Focusing is performed by rotating the lens portion of the device under test 2 forward and backward with the focus adjusting cup 21. The focus adjusting cup 21 has a hollow at the center. With this, an image can be shot while the lens is being adjusted. This focus adjusting cup 21 is driven by the focus driving motor 20.

In this case, the limit sensors 64 and 65 that detect a position of the lens when pushed as far as it goes and a tip position of the lens, respectively, are provided for controlling the lens so that the lens is fixed at these positions. The focusing chart 28 is disposed at the defined focus position with respect to the device under test 2. Then, the image signal from the device under test 2 is captured by the image capturing unit 61. Using the image, the image-size-definition measuring unit 63 performs image processing to find outer dimensions of the focusing chart and the definition of the image. The definition is obtained by converting blurring at the edge of the image into numbers. As the shot edge is more vertical, the definition is determined as being higher.

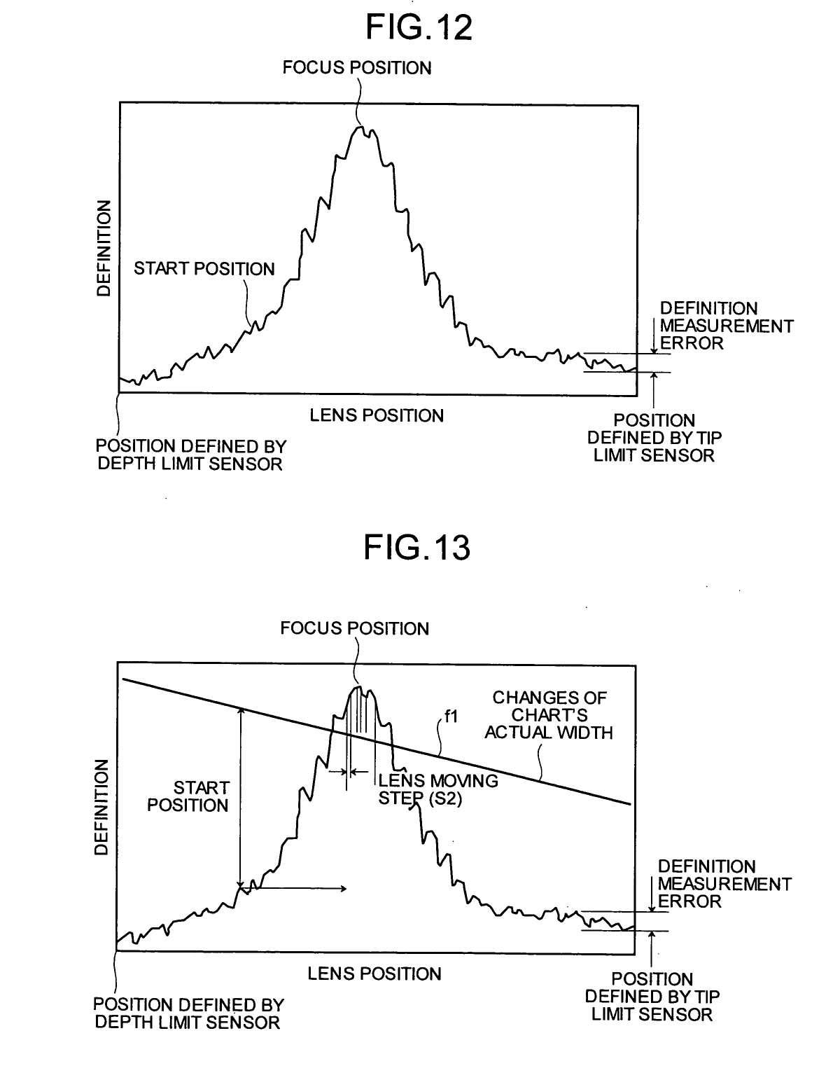

FIG. 12 is a drawing of an exemplary definition characteristic at the time of automatic focusing. The vertical axis represents definition, while the horizontal axis represents a lens position. As shown in the drawing, the lens is moved from the position defined by the depth limit sensor to the position defined by the tip limit sensor. For example, as shown in the drawing, when lens is moved from the position defined by the depth limit sensor to the position defined by the tip limit sensor, the definition is gradually increased as shown in the drawing. Due to measurement error, the definition is not smoothly changed. Then, after the lens comes to a certain position, the definition is gradually decreased. The position where the definition is at the maximum is taken as the focus position.

At the time of start of the test, the current position and a position one step forward are compared, and from its gradient, a peak is searched for toward increasing definition. Then, steps where possible peaks were found are finely examined to locate the real peak.

FIG. 13 is an illustrative drawing of lens position correction. The vertical axis represents definition, while the horizontal axis represents a lens position. There is a characteristic in which, when the lens is deviated from the focus position, the size of the original image to be shot is changed as shown in the drawing. Since the size of the image is changed by an amount approximately in proportion to the amount of movement of the lens position, the current lens position can be calculated from the size of the image. In this case, the size of the image is not linearly changed with respect to the amount of movement of the lens. Therefore, it is required that the lens position and the size of the image to be shot be calculated in advance.

Firstly, image shooting is performed at a start position. Also, a chart's width (outer rim) dimension f1 is found and, from the dimension, how much the lens is deviated with respect to the focus position is found. An amount of deviation of the lens from the found value to the focus point is found, and the lens is moved by that amount as indicated by a arrow in the drawing. The position after movement has a lens advance error or an image dimension measurement error, and therefore does not necessarily coincide with the focus position. Thus, as with the conventional technology, the definition is measured with fine steps to find the correct focus position. With such a scheme, the focusing operation can be performed at high speed. This is particularly effective when the start position of the lens is significantly deviated from the focus position.

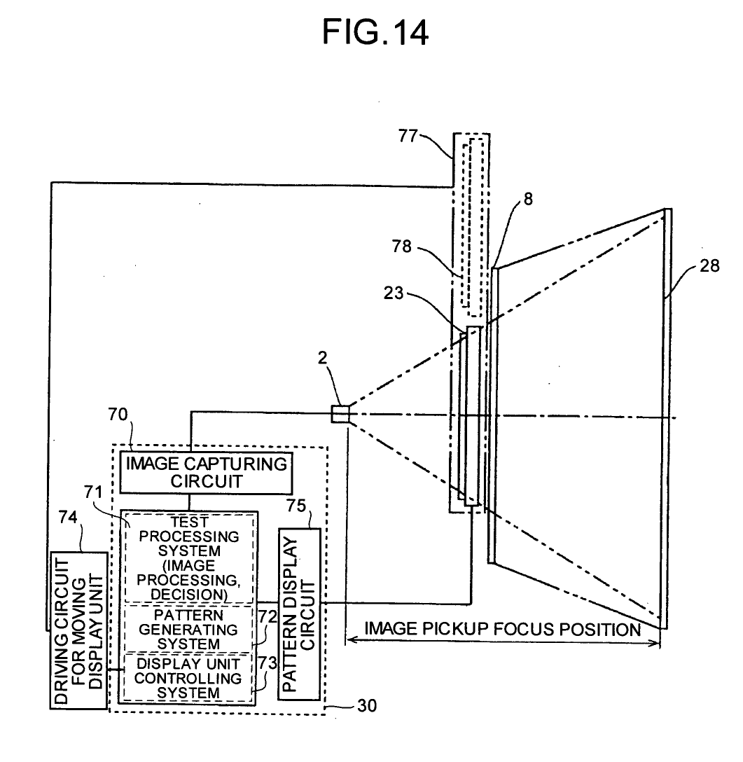

FIG. 14 is a drawing of an exemplary structure of the system controlling unit 30 (refer to FIG. 1). In the system controlling unit 30, 70 is an image capturing circuit that captures an image form the device under test 2, 71 is a test processing system, 72 is a pattern generating system, and 73 is a display unit controlling system. 74 is a driving circuit for moving the display unit, and 75 is a pattern display circuit. The driving circuit 74 for moving the display unit is a display unit moving mechanism unit for retracting the display unit to a retracting position 78.

The image capturing circuit 70 inputs the image signal of the image of the display unit 23. Then, the test processing system 71 performs predetermined image processing. The pattern display circuit 75 receives a signal from the pattern generating system 72 to output, to the display unit 23, a display pattern to be displayed on the display unit 23. With this, the displayed pattern is shot by the device under test 2. For focus adjustment, the display unit moving mechanism unit 77 is driven to move the display unit 23 to the display unit retracting position 78. With this state, the focus adjustment pattern stored on the chart paper 28 is read.

Effects of the present invention described above are listed as follows.

1) The electrical test and the image test are performed at the same place. With this, the connection between the device under test and the testing system can be made at one time, thereby preventing degradation in the terminal portion.

2) Also, since the connection between the device under test and the testing system can be made at one time, unlike the conventional technology where a connection-confirming circuit (simple electrical testing system) is required at each test stage, only one such circuit (unit) is enough, thereby reducing cost.

3) The image test and lens focusing are automatically performed, thereby stabilizing the quality and reducing the operation time.

4) Furthermore, the lens is fixed with a laser and lens fixing to dimension measurement are collectively performed. With this, no positional deviation of the lens occurs, and manufacturing tact can be dramatically reduced compared with a scheme in which an adhesive is used at another process. Still further, cumbersome operations, such as management of the adhesive, can be eliminated.

5) Also, the electrical test, the image test, and dimension measurement check before and after lens fixing are performed within the same apparatus. With this, an unnecessary fixing operation due to defective dimensions can be avoided. Furthermore, components can be reused. Still further, since all tests including the final test are completed within the apparatus, thereby providing a manufacturing apparatus with high production efficiency.

6) A display unit, such as an LCD or PDP, is used as an image test chart. With this, image test and focusing, which are conventionally performed at a plurality of examination stages, can be performed at one stage. Thus, the tests can be performed efficiently. This can reduce manufacturing cost and facility installation space.

7) With the use of the display unit, the tests can be performed with moving images. Also, with a light source with high uniformity of chromaticity or the like, the tests can be more stabilized.

8) When illumination for image test and the chart paper are switched, a mechanism unit that performs both of switching and light-shielding of an unnecessary illumination and chart paper is provided to simplify the structure of the apparatus. Also, each test is performed without ON/OFF of the light source (particularly, fluorescent lamp for illumination of the chart paper) but with light shielding. Therefore, the life of the light source can be dramatically extended.

9) The position of the display unit is finely moved. Also, with the position of the lens being deviated from the focus position, error detection in the image test due to defects of the display unit can be avoided. Therefore, a display unit of high quality is not required, thereby reducing cost.

10) The display unit is placed according to the test details. Therefore, each test can be performed without using a large display unit corresponding to the entire image pickup screen, thereby reducing cost.

11) For lens focusing, positioning is performed by determining from the image whether the initial lens focus is located in the rear or front of the focus position. With this, a focusing time can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An image-pickup-device testing method, wherein processes are performed at one stage, the processes comprising the steps of:
mounting a image pickup device under test on a test desk;
performing an electrical test on the mounted image pickup device;
performing automatic focus adjustment;
performing an image test;
performing a flicker test;
fixing a lens; and
measuring assembly dimensions of the image pickup device under test.

2. An image-pickup-device testing apparatus for performing an electrical test, an image test, and focusing and fixing of a lens of an image pickup device, the apparatus comprising:
an automatic focus adjusting mechanism that automatically perform focus adjustment of a device under test;
an image test display unit that displays a pattern for testing an image reading function of the device under test;
an electrical testing and image testing unit that performs the electrical test and the image test on the device under test;
a flicker testing unit that performs a flicker test;
a moving unit that moves various components as required; and
a system controlling unit that controls an entire operation.

3. The image-pickup-device testing apparatus according to claim 2, further comprising
a shielding unit that shields a chart for automatic focus adjustment when focus adjustment using chart paper performed by the automatic focus adjusting mechanism is completed.

4. The image-pickup-device testing apparatus according to claim 3, wherein
after the chart is shielded by the shielding unit, the electric testing and image testing unit performs the image test on the device under test.

5. The image-pickup-device testing apparatus according to claim 4, wherein
in the image test, test patterns are sequentially displayed on the image test display unit, the patterns are shot and, from images of the shot patterns, characteristics of the device under test are found.

6. The image-pickup-device testing apparatus according to claim 4, wherein
in the image test, control is performed for each display pixel of the image test display unit, and arbitrary color reproduction is obtained.

7. The image-pickup-device testing apparatus according to claim 4, wherein
when the focus adjustment performed by the automatic focus adjusting mechanism is completed, the image test display unit is disposed in front of a focus position to display an image in a blurred state for performing the image test.

8. The image-pickup-device testing apparatus according to claim 3, wherein
a dark screen test is performed in association with an operation of switching the image test display unit, the chart paper, and a light source for the flicker test.

9. The image-pickup-device testing apparatus according to claim 2, further comprising
a lens fixing unit that welds the lens to the device under test in a state at the time of completion of a series of process of automatic focus adjustment, image adjustment, and the flicker test.

10. The image-pickup-device testing apparatus according to claim 9, further comprising
a unit that measures dimensions of the device under test after a position of the lens is fixed by the lens fixing unit.
